(19) United States
(12) Patent Application Publication
(10) Pub. No.: US 2026/0254191 A1
(43) Pub. Date: Aug. 27, 2026

(54) INDIRECT OPTICAL PUMPING WITH STIMULATED RAMAN SCATTERING

(71) Applicant: The Government of the United States of America, as represented by the Secretary of the Navy, Arlington, VA (US)

(72) Inventors: Yu-Hsin Chen, Fairfax, VA (US); Victor Hasson, Beverly, MA (US); Daniel F. Gordon, Alexandria, VA (US)

(73) Assignee: The Government of the United States of America, as represented by the Secretary of the Navy, Arlington, VA (US)

(21) Appl. No.: 19/545,805

(22) Filed: Feb. 20, 2026

Related U.S. Application Data
(60) Provisional application No. 63/762,664, filed on Feb. 25, 2025.

(51) Int. Cl. H01S 3/30; H01S 3/10; H01S 3/102; H01S 3/108

(52) U.S. Cl. CPC H01S 3/305; H01S 3/10092; H01S 3/1024; H01S 3/1086

(57) ABSTRACT

An indirect optical pumping system and method are provided. In embodiments, the system includes: at least one laser source configured to generate a first laser beam; a seed laser source configured to generate a seed laser beam; a Raman resonance system comprising Raman-active molecules and gain molecules; and an optics system configured to: spatially combine the first laser beam with the seed laser beam, thereby generating a spatially combined laser beam. The spatially combined laser beam is directed through the Raman resonance system such that the first laser beam of the spatially combined laser beam excites the Raman-active molecules, and the resulting excited Raman-active molecules excite the gain molecules, resulting in amplification of the seed laser beam such that an amplified laser beam exits the Raman resonance system.

### REFERENCE TO RELATED APPLICATIONS

This application is a Nonprovisional of, and claims the benefit of priority under 35 U.S.C. § 119 based on, U.S. Provisional Patent Application No. 63/762,664 filed Feb. 25, 2025. The Provisional application and all references cited herein are hereby incorporated by reference into the present disclosure in their entirety.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case No. 212027-US03.

### BACKGROUND OF THE INVENTION

Aspects of the present invention relate generally to lasers and, more particularly, to an optical pumping system and method for high-power, ultrashort molecular gas lasers.

There is great interest in short-pulse, high-peak power lasers at long-wave infrared (LWIR) wavelengths for various research fields including nonlinear optics, atomic, molecular and optical (AMO) physics, intense laser-plasma interactions, generation of secondary radiation, and directed energy applications. One existing technique is multi-staged nonlinear down-conversion from a near infrared (NIR), ultrashort solid-state laser. However, efficiency with this technique is extremely low, e.g., 0.1% at a 10 micrometer (μm) wavelength. On the other hand, carbon dioxide (CO₂) lasers are capable of delivering high-energy pulses in the wavelength range of 9-11 μm, and such lasers have demonstrated multi-terawatt peak power with picosecond pulse duration. See, for example, D. Haberberger, S. Tochitsky, and C. Joshi, “Fifteen terawatt picosecond CO₂ laser system,” Opt. Express 18, 17865-17875 (2010), and Mikhail N. Polyanskiy, Igor V. Pogorelsky, Marcus Babzien, and Mark A. Palmer, “Demonstration of a 2 ps, 5 TW peak power, long-wave infrared laser based on chirped-pulse amplification with mixed-isotope CO₂ amplifiers,” OSA Continuum 3, 459-472 (2020).

Most CO₂ lasers are indirectly pumped by electron impact excitation of nitrogen (N₂) molecules through glow discharges, which limits achievable gain cross section and pressure broadening, and thus poses a barrier to higher energy/peak power through scaling. It also leads to bulky system components, low repetition rates, high operating and maintenance costs, and reduced reliability. In an attempt to address these limitations, researchers have studied “direct” optical pumping at multiple CO₂ absorption spectral bands at mid-infrared wavelengths, mainly with hydrogen bromide (HBr, λ~4.3 μm) and hydrogen fluoride (HF, λ~2.7 μm) chemical lasers. However, such chemical lasers are not an ideal choice as a pump source due to practical and safety concerns. The iron doped zinc selenide (Fe:ZnSe) laser is a relatively new technology, and its energy scalability has not demonstrated so far. It cannot be externally synchronized and therefore cannot be used as the pump source in a master oscillator-power amplifier (MOPA) architecture.

### SUMMARY OF THE INVENTION

In a first aspect of the invention, there is an indirect optical pumping system including: at least one laser source configured to generate a first laser beam; a seed laser source configured to generate a seed laser beam; a Raman resonance system comprising Raman-active molecules and gain molecules; and an optics system configured to: spatially combine the first laser beam with the seed laser beam, thereby generating a spatially combined laser beam. The spatially combined laser beam is directed through the Raman resonance system such that the first laser beam of the spatially combined laser beam excites the Raman-active molecules, and the resulting excited Raman-active molecules excite the gain molecules, resulting in amplification of the seed laser beam such that an amplified laser beam exits the Raman resonance system.

In embodiments, the at least one laser source comprises a first laser source and a second laser source. In implementations, the first laser source is a pump laser source, the second laser source is a Stokes laser source, and the first laser beam is generated from a pump laser beam and a Stokes laser beam. In embodiments, the amplified laser beam has an ultrashort pulse duration of 5 picoseconds (ps) or shorter. In some embodiments, the pulse duration is 1 ps or shorter. In aspects of the invention, the pump laser beam is temporally and spatially combined with the Stokes laser beam to generate the first laser beam. The system may also include a dichroic mirror, wherein the amplified laser beam existing the Raman resonance system is directed to the dichroic mirror, thereby separating laser energy of a predetermined wavelength or wavelengths from the amplified laser beam, resulting in an amplified seed laser beam having a higher total energy output than the seed laser beam. In implementations, the seed laser source is a broadband long-wave infrared (LWIR) source configured to generate a LWIR beam, wherein the LWIR beam has a bandwidth equivalent to a transform-limited pulse duration of 5 picoseconds (ps) or shorter.

The Raman resonance system may include a pressure chamber defining an environment under pressure, and a gas within the pressure chamber including the Raman-active molecules and the gain molecules. In embodiments, the Raman-active molecules are selected from the group consisting of: nitrogen gas (N₂), carbon monoxide (CO), and a combination thereof. In implementations, the gain molecules are selected from the group consisting of: carbon dioxide (CO₂), nitrous oxide (N₂O), and a combination thereof. In some instances, the gas includes a buffer gas, which may be helium (He). In some embodiments, the seed laser beam has a pulse duration of less than or equal to 1 picosecond (ps). The at least one laser source may comprise a first laser source and a frequency converted configured to convert a laser beam having a first frequency generated by the first laser source into another laser beam having a second frequency, wherein the first frequency is different from the second frequency.

In a second aspect of the invention, there is an indirect optical pumping method including: spatially combining a first laser beam and a seed laser beam, thereby generating a spatially combined laser beam; and directing the spatially combined laser beam through a Raman resonance system comprising Raman-active molecules and gain molecules; wherein the first laser beam of the spatially combined laser beam excites the Raman-active molecules, and the resulting excited Raman-active molecules excite the gain molecules, resulting in amplification of the seed laser beam such that an amplified laser beam exits the Raman resonance system.

In implementations, the method includes spatially and temporally combining a pump laser beam and a Stokes laser beam, thereby generating the first laser beam. In embodiments, the method includes directing the amplified laser beam to a dichroic mirror, thereby separating laser energy of a predetermined wavelength or wavelengths from the amplified laser beam, resulting in an amplified seed laser beam having a higher total energy output than the seed laser beam. In some instances, the amplified seed laser beam is a broadband long-wave infrared (LWIR) beam, wherein the LWIR beam has a bandwidth equivalent to a transform-limited pulse duration of 5 picoseconds (ps) or shorter. In implementations, the Raman resonance system comprises a pressure chamber defining an environment under pressure, and a gas within the pressure chamber including the Raman-active molecules and the gain molecules. In some embodiments, the Raman-active molecules are selected from the group consisting of: nitrogen gas (N₂), carbon monoxide (CO), and a combination thereof. In some instances, the gain molecules are selected from the group consisting of: carbon dioxide (CO₂), nitrous oxide (N₂O), and a combination thereof.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 shows an exemplary laser amplification system in accordance with embodiments of the invention.

FIG. 2 is a graph illustrating calculated on-axis population (vertical axis) of vibrationally excited N₂ molecules when focusing pump and Stokes beams in high-pressure N₂ gas.

FIG. 3A shows another laser amplification system, in accordance with embodiments of the invention, which utilizes a broadband LWIR laser source and two additional laser sources.

FIG. 3B shows another laser amplification system, in accordance with embodiments of the invention, which utilizes a broadband LWIR laser source and one other laser source to generate pump and Stokes frequencies.

FIG. 4A shows a laser resonator system, in accordance with embodiments of the invention.

FIG. 4B shows another laser resonator system, in accordance with embodiments of the invention.

FIG. 5 shows a flowchart of an exemplary amplification method in accordance with aspects of the present invention.

FIG. 6 shows a flowchart of an exemplary resonator method in accordance with aspects of the present invention.

### DETAILED DESCRIPTION

Aspects of the present invention relate generally to lasers and, more particularly, to an optical pumping system and method for high-power, ultrashort molecular gas lasers. Implementations of the invention provide a system for lasers at the wavelength of long-wave infrared (LWIR). Implementations of the invention utilize an “indirect” optical pumping method, that results in optical excitation of a first species of atoms/molecules. The resulting energy stored in the first species of atoms/molecules (Raman-active molecules) is transferred to a second species of atoms/molecules (gain molecules), wherein the second species serves as a laser gain medium for producing a laser output. In laser resonator embodiments, the second species serves as a laser gain medium for producing a laser output, while in laser amplifier embodiments, the second species serves as a laser gain medium for producing an amplified seed laser beam.

Unlike indirect optical pumping methods of the present invention, direct optical pumping methods result in all of the atoms or molecules being directly pumped with light. Advantageously, in contrast to direct optical pumping which requires high-power, short-pulse laser technologies precisely overlapping rather narrow mid-infrared absorption bands of the gain medium, implementations of the invention are much less sensitive to the pump wavelength and therefore should work with any high-power laser technology.

In accordance with embodiments of the invention, a pump laser wavelength does not have to match an absorption line corresponding to excitation from lower to upper lasing levels in the gain medium (a material that amplifies light through a process called stimulated emission). Instead, the optical pump energy is first absorbed and stored in an intermediate species of atoms or molecules (Raman active molecules), and is then transferred to the gain medium through nonradiative processes such as collision.

In one embodiment, optical energy is transferred to vibration modes of intermediate molecules through stimulated Raman scattering (SRS), as the energy reservoir for pumping molecular gas lasers. This is particularly suitable for pumping high-pressure, broadband LWIR lasers such as carbon dioxide (CO₂) and nitrous oxide (N₂O) lasers capable of ultrashort pulse durations. The term “ultrashort” as used herein refers to 5 picoseconds (ps) or shorter. While direct optical pumping removes all restrictions imposed by high-pressure discharges, indirect optical pumping systems of the present invention are relatively insensitive to the choice of pump wavelengths, and can utilize any well-developed laser technologies scalable to high power, high energy, and high rep rate, such as neodymium-doped yttrium aluminum garnet (Nd:YAG) lasers.

In embodiments, an indirect optical pumping system is provided, including: at least one laser source configured to generate a first (pump) laser beam having a first frequency and a second (Stoke) laser beam having a second frequency; a seed laser beam source, such as broadband long-wave infrared (LWIR) source configured to generate a LWIR beam; a pressure chamber defining an environment under pressure; a gas within the pressure chamber including Raman-active molecules and gain molecules; and an optics system configured to spatially and temporally combine the pump and Stokes laser beams into a combined laser beam, and spatially combine the seed laser beam with the combined laser beam to produce a spatially combined laser beam. In implementations, the optics system further directs the spatially combined laser beam through the pressure chamber to generate an amplified laser beam. In embodiments, the first laser beam of the spatially combined laser beam excites the Raman-active molecules and the excited Raman-active molecules excite the gain molecules, resulting in the amplified laser beam (e.g., LWIR beam) exiting the pressure chamber.

The term seed laser beam source as used herein refers to a relatively low-power, high-stability, and highly coherent laser source used to inject an initial signal beam or seed laser beam into an amplifier or resonator. In general, the seed laser defines the precise spectral (wavelength), temporal (pulse shape), and spatial characteristics of a final, higher-power laser output of an amplifier.

In a typical discharge-pumped CO₂ laser, N₂ molecules are pumped to a first excited vibration level by energetic electrons, and subsequently transfers the energy to an upper lasing level (first excited asymmetric stretching (v₃) mode) of the CO₂ molecules through V-V collisions. An alternative approach to vibrationally excited N₂ is through SRS, which is a nonlinear optical process where a pump photon red-shifts to a “Stokes” photon while transferring a portion of its energy to a molecule. Excitation through SRS can be efficient, as a population of ~33% in first excited vibrational level in 1 atm N₂ has been experimentally demonstrated. See Tai Ahn et al., Determination of nitrogen V-V transfer rates by stimulated Raman pumping, Chemical Physics, Volume 298, Issues 1-3, 2004, Pages 233-240. Indirect optical pumping for N₂O is also possible through SRS in N₂ or carbon monoxide (CO).

The following SRS Stokes intensity growth equation EQ (1) implies that there must be excitations of N₂ molecules from a vibrational ground state (v=0) to an excited state (v=1) assuming a two-level system.

$${dI}_{s} / dz = {g}_{R} {I}_{p} {I}_{s} , \qquad EQ ( 1 )$$

IₚIₛ is Stokes (pump) intensity, dz is the propagation distance, and g_{R} is the Raman gain coefficient.

The temporal evolution of N₂ vibrational levels should follow the second equation EQ (2), where vₛ (vₚ) is Stokes (pump) frequency, n₀(n₁) is the ground (excited) state molecular number density, dn₁/dt stands for the rate of change of the number density of a species over time, t is time, and Pₐₜₘ is atmospheric pressure.

$$d {n}_{1} / dt = {( h {ν}_{s} )}^{- 1} {g}_{R} ( t ) {I}_{p} ( t ) {I}_{s} ( t ) with \\ {g}_{R} ( t ) = {g}_{R 0 , atm} \cdot {P}_{atm} \cdot ( {n}_{0} - {n}_{1} ) / ( {n}_{0} + {n}_{1} ) . \qquad EQ ( 2 )$$

With significant ground state depletion, the Raman gain coefficient g_{R}(t) is no longer a constant. Note that g_{R} scales approximately linearly with N₂ pressure when pressure (P)≥~10 atm, and therefore it is convenient to express g_{R} as the product of gain coefficient per unit pressure g_{R0,atm} and gas pressure Pₐₜₘ. In a mixture of nitrogen and carbon dioxide gas (N₂—CO₂) or nitrogen and nitrous oxide gas (N₂-N₂O), several competing processes may reduce the energy transfer efficiency to upper lasing levels of CO₂ (N₂O) from SRS-excited N₂, such as SRS excitation of CO₂ (v₁) (100), CO₂ (2v₂) (020), and N₂O (v₁) (100) modes. Therefore, considerable initial laser energies at both pump and N₂ Stokes wavelengths are required, as SRS excitation is most efficient with Iₚ=Iₛ. Also note that dn₁/dt scales with ~vₛ/vₚ. For N₂ Raman shift 2331 cm⁻¹ with a Nd:YAG pump laser, the excitation rate only varies slightly between 1064 nanometers (nm) and 532 nm pump wavelength, as (dn₁/dt)|_{λ}_{ₚ}_{=1064 nm}/(dn₁/dt)|_{λ}_{ₚ}_{=532 nm}=0.86.

In one example, taking an undepleted Raman gain coefficient value of 1.6 centimeters per terawatt at atmospheric pressure (cm/(TW·atm)), calculations show that with a typical Nd:YAG pump laser pulse duration of 10 nanoseconds (ns), ~40% of N₂ molecules can be excited to v=1 vibrational level with Iₚ=Iₛ=25 gigawatts per square centimeter (GW/cm²). With 40% N₂ excitation, the gain coefficient should be close to a typical discharge-pumped CO₂ laser.

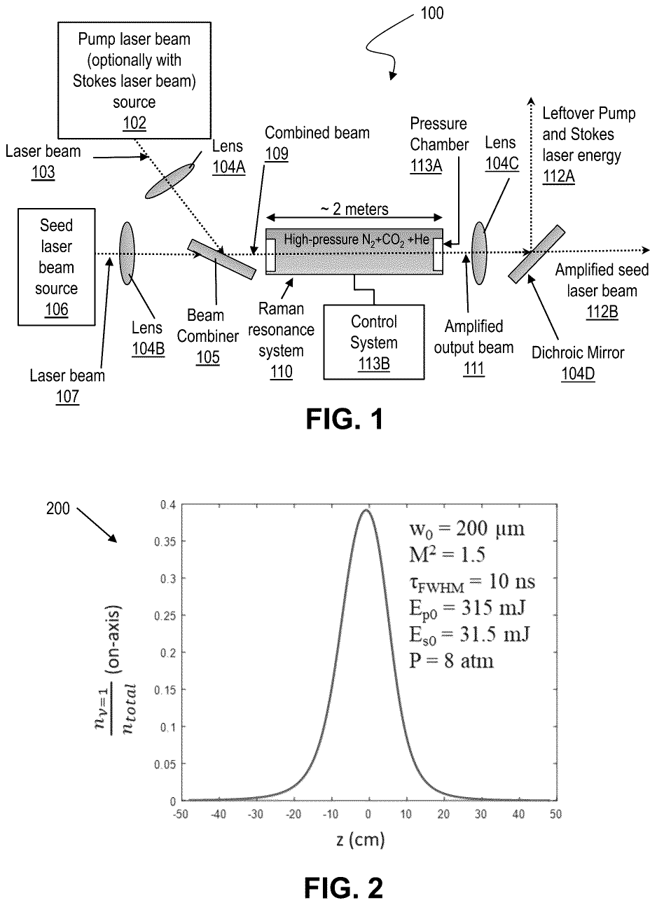

FIG. 1 shows an exemplary laser amplification system 100 in accordance with embodiments of the invention. FIG. 1 is shown for illustrative purposes, and the present invention is not intended to be limited to the configuration shown. For example, other configurations may utilize pressurized waveguides with hollow-core fibers, or Herriott cells with multiple passes.

As illustrated, the amplification system of FIG. 1 includes a laser beam 103 provided by either a pump laser beam source, or combined pump and Stokes laser beam sources 102. In general, pump laser sources typically comprise a shorter-wavelength, higher-energy laser as compared to Stokes laser sources. Conversely, Stokes laser sources typically produce a longer-wavelength, lower-energy laser than the pump laser source that, when combined with a pump laser beam, cause a stimulated Raman gain followed by the pumping of the gain medium with the excited Raman medium. When both the pump and Stokes laser beam sources are utilized, the beams from each are temporally and spatially combined to produce the laser beam 103. Initially, it is noted that different optical elements of an optics system may be utilized to direct, combine, split, and/or concentrate energy within the system 100. The example of FIG. 1 depicts optional lenses 104A-104C. However, it should be understood that different mirrors, lenses, beam splitters or other optical elements could be utilized in accordance with implementations of the invention, and the invention is not intended to be limited to particular optical element configurations.

In embodiments, the (first) laser beam 103 is directed to a beam combiner 105 (e.g., by a lens 104A). Similarly, a seed laser beam 107 from a seed laser beam source 106 is directed to the beam combiner 105 (e.g., by a lens 104B). In implementations, the seed laser beam source is an LWIR laser source capable of ultrashort pulse durations. In embodiments, the LWIR beam generated has a bandwidth equivalent to a transform-limited pulse duration of 5 picoseconds (ps) or shorter, or a 1 ps or shorter.

In implementations, when the laser beam 103 is composed of pump and Stokes frequencies, the difference in the pump and Stokes frequencies match a Raman resonance frequency of a Raman resonance system 110. In the example of FIG. 1, the Raman resonance system 110 comprises a pressure chamber 113A having a width of approximately 2 meters, housing Raman-active molecules, gain molecules and a buffer gas, as well as a control system 113B configured to control the pressure and/or flow of gas within the pressure chamber 113A. Specifically, the exemplary pressure chamber 113A is filled with nitrogen (N₂), carbon dioxide (CO₂) and helium (He) gasses, under high pressure. The term high pressure as used herein refers to a pressure of greater or equal to 10 atmospheres (atm).

In implementations, the beam combiner 105 spatially combines beams 103 and 107 into a combined beam 109, which is directed through the Raman resonance system 110 (pressure chamber 113A), thereby generating an amplified output beam 111. While a pressure chamber 113A with Raman-active gas molecules is shown, it is contemplated that a Raman resonance system comprised of a solid or liquid material having the required Raman active molecules to produce an amplified output beam 111 may be utilized in accordance with embodiments of the invention. The amplified output beam 111 exits the Raman resonance system 110 and is directed (e.g., by a lens 104C) to a dichroic mirror 104D. The dichroic mirror 104D is configured to separate pump laser energy of a predetermined wavelength (e.g., leftover pump laser energy, or leftover combined pump and Stokes laser energy 112A) from the amplified output beam 111, thus producing the amplified seed laser beam 112B.

FIG. 2 is a graph 200 illustrating calculated on-axis population (vertical axis) of vibrationally excited N₂ molecules when focusing pump and Stokes beams in high-pressure N₂ gas In FIG. 2, w₀ is the radius of the pump and Stokes beams at focus, M² is a laser beam quality factor, τ_{FWHM} is the pump and Stokes full width at half maximum (FWHM) pulse duration, Eₚ₀ is an input pump energy, Eₛ₀ is the input Stokes energy, and P is the nitrogen gas pressure. The horizontal axis (labeled as z) represents distance of propagation (z) of pump and Stokes beams in the gas, while z=0 represent the location of focus. In the example shown, w₀=200 μm, M²=1.5, τ_{FWHM}=10 ns, Eₚ₀=315 mJ, Eₛ₀=31.5 mJ, and P=8 atm. With the given parameters in FIG. 2, an averaged population of N₂ upper state nᵥ₌₁/nₜₒₜₐₗ~0.3 over ~10 centimeters (cm) of propagation distance near the focus can be achieved, which corresponds to a single-pass amplification factor of ~30.

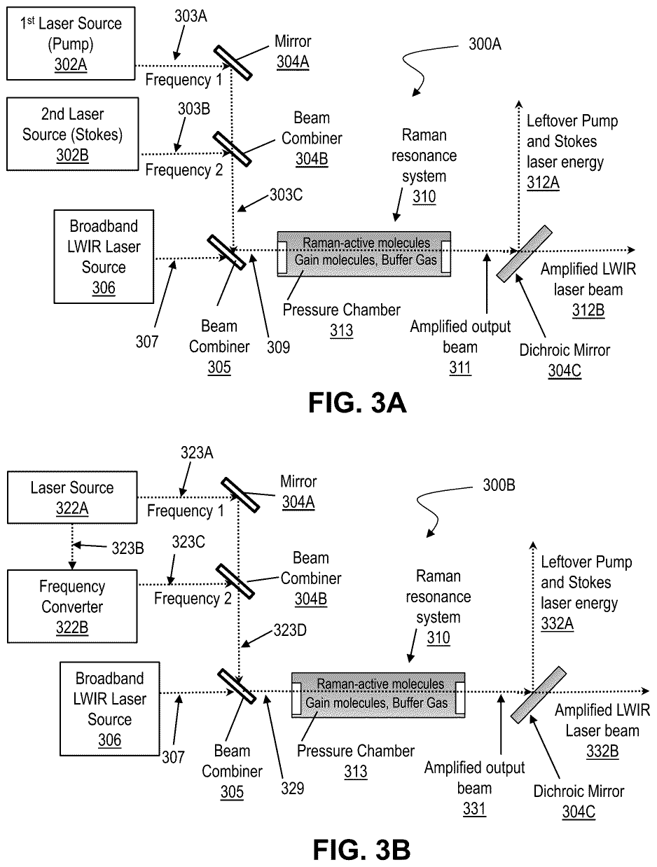

FIG. 3A shows another laser amplification system 300A, in accordance with embodiments of the invention, which utilizes a broadband LWIR laser source and two additional laser sources. As illustrated, the amplification system of FIG. 3A includes a laser beam 303A from a first laser source 302A, and a second laser beam 303B from a second laser source 302B, wherein the first laser beam 303A has a first frequency, and the second laser beam 303B has a second frequency different from the first frequency. In embodiments, the first and second laser sources are temporally synchronized. In implementations, the first laser source 302A is a pump laser source and the second laser source 302B is a Stokes laser source. In embodiments, the first and second beams 303A and 303B are temporally and spatially combined by an optics system (e.g., beam combiner 304B) to create laser beam 303C, which is directed to a beam combiner 305. Similarly, a seed laser beam 307 from a seed laser beam source (a broadband LWIR laser source capable of ultrashort pulse durations) 306 is directed to the beam combiner 305 (e.g., by one or more elements of an optics system). Various optical elements (e.g., mirror 304A, beam combiner 304B) may be utilized to direct laser beam energy, and the invention is not intended to be limited to the optical system shown.

In implementations, the laser beam 303A and the laser beam 303B have different frequencies, and the difference of the frequencies match the Raman resonance frequency of a Raman resonance system 310. In the example of FIG. 3A, the Raman resonance system 310 comprises: a pressure chamber 313 housing Raman-active molecules, LWIR gain molecules, and a buffer gas; and a control system (not shown) configured to control the pressure and/or flow of gas within the pressure chamber 313.

In embodiments, the beam combiner 305 spatially combines beams 303C and 307 into a spatially combined beam 309, which is directed through the Raman resonance system 310 (pressure chamber 313), thereby generating an amplified output beam 311 (i.e., an amplification of beam 309). In this way, the LWIR laser beam 307 is amplified by the Raman Resonance system 310. While a pressure chamber 313 is shown, it is contemplated that a Raman resonance system comprised of a solid or liquid material having the required Raman active molecules to produce an amplified output beam 311 may be utilized in accordance with embodiments of the invention.

The amplified output beam 311 exits the Raman resonance system 310 and is directed to a dichroic mirror 304C. The dichroic mirror 304C is configured to separate laser energy of a predetermined wavelength(s) 312A (e.g., leftover pump laser energy, or leftover combined pump and stokes laser energy) from the amplified output beam 311, thus producing the amplified LWIR seed laser beam 312B, wherein 312B is an amplification of beam 307.

FIG. 3B shows a laser amplification system 300B, in accordance with embodiments of the invention, which utilizes a broadband LWIR laser source and one other laser source to generate pump and Stokes frequencies. In the example of FIG. 3B, a laser source 322A generates a first laser beam 323A having a first frequency (e.g., pump frequency). The laser source 322A also generates a second laser beam 323B of the same frequency, which is converted by a frequency converter 322B to a laser beam 323C having a second frequency (e.g., Stokes frequency) different from the first frequency. In implementations, the difference of the frequencies match the Raman resonance frequency of a Raman resonance system 310.

The first and third laser beams 323A and 323C are directed (e.g., by an optics system) to a beam combiner 304B. In embodiments, the first and third beams 323A and 323C are temporally and spatially combined by an optics system (e.g., beam combiner 304B) to create laser beam 323D, which is directed to a beam combiner 305. Similarly, a seed laser beam 307 from a seed laser beam source (a broadband LWIR laser source capable of ultrashort pulse durations) 306 is directed to the beam combiner 305 (e.g., by one or more elements of an optics system). Various optical elements may be utilized to direct laser beam energy, and the invention is not intended to be limited to the optical system shown. It should be understood that the optics system of FIG. 3B may include optical components for timing adjustments between the laser 323A and the laser 323C. For example, an optical delay line may be located in the path of beam 323A between laser source 322A and optical element (mirror) 304A.

The beam combiner 305 spatially combines beams 307 and 323D into a spatially combined beam 329, which is directed through the Raman resonance system 310 (pressure chamber 313), thereby generating an amplified output beam 331 (i.e., an amplification of beam 329) in the same manner described above with respect to system 300A.

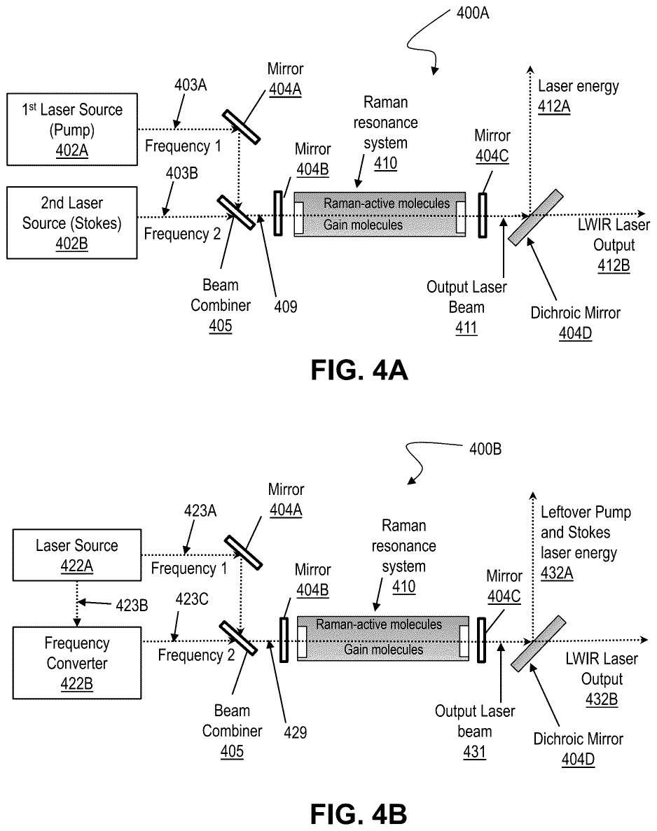

FIG. 4A shows a laser resonator system 400A, in accordance with embodiments of the invention. In the example of FIG. 4A, a first laser source (e.g., a pump laser source) 402A produces a first laser beam 403A having a first frequency, which is directed (e.g., by elements of an optics system) to a beam combiner 405. Concurrently, a second laser source (e.g., a Stokes laser source) 402B produces a second laser beam 403B at a second frequency different from the first frequency, which is directed (e.g., by one or more elements of the optics system) to the beam combiner 405. The beam combiner 405 spatially and temporally combines the beams 403A and 403B, and the resulting combined laser beam 409 is directed through a Raman resonance system 410, thereby generating an output laser beam 411. The Raman resonance system 410 may be the same as the Raman Resonance system 310 of FIGS. 3A, 3B.

The output laser beam 411 exits the Raman resonance system 410 and is directed (e.g., by one or more optical elements) to a dichroic mirror 404D. The dichroic mirror 404D is configured to separate laser energy of a predetermined wavelength(s) 412A from the output laser beam 411, thus producing a LWIR laser output beam 412B. In embodiments, mirrors 404B and 404C are utilized to form a laser resonator cavity to generate the output beam 411. In implementations, the mirror 404B is an end mirror and the mirror 404C is an output coupler. However, it should be understood that different types/configurations of laser resonators may be utilized in accordance with embodiments of the invention, and the invention is not intended to be limited to the particular configuration shown. The LWIR laser output 412B is a long pulse output, meaning the pulse duration is greater than one (1) nanosecond. It should be understood that different optical elements (e.g., lenses and mirrors) may be utilized in different combinations, and the invention is not intended to be limited to the particular arrangement of optical elements shown.

FIG. 4B shows a laser resonator system 400B, in accordance with embodiments of the invention. In the example of FIG. 4B, at least one laser source 422A produces first and second laser beams 423A, 423B at a first frequency. The first laser beam 423A is directed (e.g., by a mirror 404A of an optics system) to a beam combiner 405. The second laser beam 423B is directed (e.g., by the optics system) to a frequency converter 422B configured to convert the second laser beam 423B to a third laser beam 423C having a second frequency different from the first frequency, and the third laser beam 423C is directed (e.g., by the optics system) to the beam combiner 405. It should be understood that the optics system of FIG. 4B may include optical components for timing adjustments. For example, an optical delay line may be located in the path of beam 423A between laser source 422A and optical element (mirror) 404A.

The beam combiner 405 spatially and temporally combines the beams 423A and 423C, and the resulting combined laser beam 429 is directed through Raman resonance system 410 (e.g., by the optics system), thereby generating an output laser beam 431. The Raman resonance system 410 may be the same as the Raman Resonance system 310 of FIGS. 3A, 3B. The output laser beam 431 exits the Raman resonance system 410 and is directed (e.g., by one or more optical elements) to a dichroic mirror 404D. The dichroic mirror 404D is configured to separate laser energy 432A of a predetermined wavelength(s) from the output laser beam 431, thus producing an LWIR laser beam output 432B.

In implementations, the above-identified systems include Raman-active molecules in the pressure chambers selected from N₂, CO, and combinations thereof, and gain molecules selected from CO₂, N₂O, and combinations thereof. In embodiments, the pressure chambers also include one or more buffer gasses, such as He. In implementations, the first and second laser beams of a system have a pulse duration of between 1-100 nanoseconds.

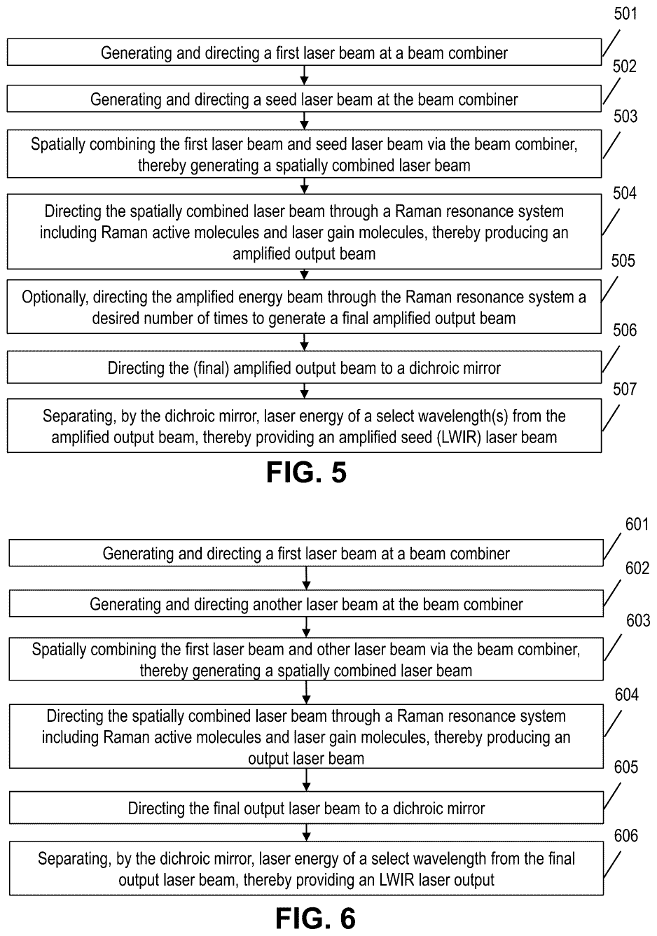

FIG. 5 shows a flowchart of an exemplary amplification method in accordance with aspects of the present invention. The steps of FIG. 5 may be performed in the environments of FIG. 1, 3A or 3B, for example.

At 501 at least one laser beam source (e.g., 102, 302A/302B, 322A) generates a first laser beam (e.g., 103, 303C, 323A) which is directed (e.g., by one or more optical elements) to a beam combiner (e.g., 105, 304B). In general, a beam combiner is an optical device that merges two or more light beams, often of different wavelengths or polarizations, into a single output beam. In embodiments, a conventional beam combiner is utilized in accordance with embodiments of the invention. In implementations, the at least one laser beam source comprises a pump laser beam source and a frequency converter that converts a pump laser beam (e.g., 323B) into a Stokes laser beam (e.g., 323C), and the first laser beam is comprised of a laser beam from the pump laser beam source having a first frequency, which is combined temporally and spatially with the Stokes laser beam having a second frequency different from the first frequency. In other implementations, the at least one laser beam source comprises combined pump and Stokes laser beam sources (e.g., 302A, 302B), and the first laser beam is comprised of a laser beam from the pump laser beam source having a first frequency, which is combined temporally and spatially with a laser beam from the Stokes laser beam source having a second frequency different from the first frequency.

At 502, a (seed) laser beam source (e.g., 106, 306) generates a seed laser beam (e.g., 107, 307), and the seed laser beam is directed at the beam combiner (e.g., 105, 305), such as by one or more optical elements of an optics system. In implementations, the seed laser beam comprises a broadband long-wave infrared (LWIR) beam capable of ultrashort pulse durations.

At 503, the beam combiner (e.g., 105, 305) spatially combines the first laser beam (e.g., 103, 303C, 323D) and the seed laser beam (e.g., 107, 307), thereby generating a spatially combined laser beam (e.g., 109, 309, 329).

At 504, the spatially combined laser beam (e.g., 109, 309, 329) is directed (e.g., by one or more optical elements of an optics system) through a Raman resonance system (e.g., 110, 310) including Raman active molecules and a laser gain medium, thereby producing an amplified output beam (e.g., 111, 311, 331) exiting from the Raman resonance system. In general, the Raman resonance system is utilized to extract a portion of the energy from the first laser beam (e.g., 103, 303C, 323D), and store that energy in the Raman-active molecules. The energy stored in the Raman-active molecules is then transferred to the laser gain medium, which results in the amplified output beam (e.g., 111, 311, 331).

In aspects of the invention, the Raman resonance system is in the form of a pressure chamber (e.g., 113A, 313) with a control system (e.g., 113B). In embodiments, the Raman-active molecules are selected from: nitrogen gas (N₂), carbon monoxide (CO), and combinations thereof. In general, the term laser gain medium (or active medium) refers to a core material (solid, liquid or gas) that gets energized (pumped) to amplify light through stimulated emission, creating a coherent laser beam. In implementations, the laser gain medium is selected from: carbon dioxide (CO₂), nitrous oxide (N₂O), and combinations thereof. In embodiments, the Raman resonance system also includes one or more buffer gases, such as helium (He).

In some embodiments, the amplification system is a multi-pass amplifier. Optionally, at 505, the amplified output beam exiting the Raman resonance system may be directed through the Raman resonance system, and this step may be repeated any number of desired times until a final amplified output beam with desired characteristics is generated by the Raman resonance system. Various optics system configuration may be utilized, and the present invention is not intended to be limited to a specific optical element configuration in order to perform step 505.

At 506, the (final) amplified output beam (e.g., 111, 311, 331) is directed (e.g., by one or more optical elements) to a dichroic mirror (e.g., 104D, 304C) configured to reflect predetermined wavelengths of light while transmitting others.

At 507, the dichroic mirror (e.g., 104D, 304C) filters out predetermined wavelengths of light (e.g., 112A, 312A, 323A) while letting an amplified seed laser beam (e.g., 112B, 312B, 332B) transmit through the dichroic mirror. The amplified seed laser beam may then be directed as desired (e.g., to a target) by one or more optical elements of an optics system, such as lenses, mirror, filters, beam splitters, prisms, waveplates, fiber optics, etc.

Based on the above, it should be understood that implementations of the invention are configured to amplify broadband, ultrashort laser pulses at long-wave infrared (LWIR) wavelength. The term “ultrashort” as used herein refers to 5 picoseconds (ps) or shorter. In implementations, broadband, ultrashort pulse capability is enabled by high gas pressure used in the (gain+Raman) media of the Raman resonance system (e.g., 110, 310, 410). While it is known to directly amplify ultrashort LWIR pulses using discharge pumping in high-pressure (up to about 10 atm) gases, implementations of the invention use indirect optical pumping in high-pressure gases for amplifying broadband, ultrashort LWIR laser pulses. Advantageously, this technique of the present invention is insensitive to the choice of pump laser wavelength. Furthermore, this technique is also applicable at mid-wave infrared (MWIR) wavelength; for example, a CO₂ laser operating at a wavelength of 4.3 μm.

FIG. 6 shows a flowchart of an exemplary laser resonator method in accordance with aspects of the present invention. The steps of FIG. 6 may be performed in the environments of FIG. 4A or 4B, for example.

At 601 at least one laser beam source (e.g., 402A, 422A) generates a first laser beam (e.g., 403A, 423A) which is directed (e.g., by one or more optical elements) to a beam combiner (e.g., 405). In general, a beam combiner is an optical device that merges two or more light beams, often of different wavelengths or polarizations, into a single output beam. In embodiments, a conventional beam combiner is utilized in accordance with embodiments of the invention. In implementations, the at least one laser beam source comprises a pump laser beam source.

At 602, another laser beam source (e.g., 402B, 422B) outputs another laser beam (e.g., 403B, 423C), and the other laser beam is directed at the beam combiner (e.g., 405), such as by one or more optical elements of an optics system. In some embodiments, the first laser beam source (e.g., 422A) generates a second laser beam (e.g., 423BB), which is converted at a frequency converter (e.g., 422B) into the other laser beam (e.g., 423C), which has a frequency different from the frequency of the first laser beam (e.g., 423A). In implementations, the second laser beam source is a Stokes laser beam source.

At 603, the beam combiner (e.g., 405) spatially and temporally combines the first laser beam (e.g., 403A, and the other laser beam (e.g., 403B, 423C), thereby generating a spatially combined laser beam (e.g., 409, 429).

At 604, the spatially and temporally combined laser beam (e.g., 409, 429) is directed (e.g., by one or more optical elements of an optics system) through a Raman resonance system (e.g., 410) including Raman active molecules and a laser gain medium, thereby producing an output laser beam (e.g., 411, 431) exiting from the Raman resonance system. In general, the Raman resonance system is utilized to extract a portion of the energy from the first laser beam (e.g., 403A, 423A), and store that energy in the Raman-active molecules. The energy stored in the Raman-active molecules is then transferred to the laser gain medium, which results in the output laser beam (e.g., 411, 431). The Raman resonance system may be the same as the Raman resonance system described above with respect to FIGS. 1, 3A, and 3B.

At 605, the output laser beam (e.g., 411, 431) is directed (e.g., by one or more optical elements) to a dichroic mirror (e.g., 404D) configured to reflect predetermine wavelengths of light while transmitting others.

At 606, the dichroic mirror (e.g., 404D) filters out predetermined wavelengths of light (e.g., 412A, 432A) while letting an LWIR laser output (e.g., 412B, 432B) transmit through the dichroic mirror. The LWIR laser output may then be directed as desired (e.g., to a target) by one or more optical elements of the optics system, such as lenses, mirror, filters, beam splitters, prisms, waveplates, fiber optics, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the embodiments described. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An indirect optical pumping system comprising:
at least one laser source configured to generate a first laser beam;
a seed laser source configured to generate a seed laser beam;
a Raman resonance system comprising Raman-active molecules and gain molecules; and
an optics system configured to: spatially combine the first laser beam with the seed laser beam, thereby generating a spatially combined laser beam, wherein the spatially combined laser beam is directed through the Raman resonance system such that the first laser beam of the spatially combined laser beam excites the Raman-active molecules, and the resulting excited Raman-active molecules excite the gain molecules, resulting in amplification of the seed laser beam such that an amplified laser beam exits the Raman resonance system.

2. The indirect optical pumping system of claim 1, wherein the at least one laser source comprises a first laser source and a second laser source.

3. The indirect optical pumping system of claim 2, wherein the first laser source is a pump laser source, the second laser source is a Stokes laser source, and the first laser beam is generated from a pump laser beam and a Stokes laser beam.

4. The indirect optical pumping system of claim 1, wherein the amplified laser beam has an ultrashort pulse duration of 5 picoseconds (ps) or shorter.

5. The indirect optical pumping system of claim 3, wherein the pump laser beam is temporally and spatially combined with the Stokes laser beam to generate the first laser beam.

6. The indirect optical pumping system of claim 1, further comprising a dichroic mirror, wherein the amplified laser beam exiting the Raman resonance system is directed to the dichroic mirror, thereby separating laser energy of a predetermined wavelength or wavelengths from the amplified laser beam, resulting in an amplified seed laser beam having a higher total energy output than the seed laser beam.

7. The indirect optical pumping system of claim 1, wherein the seed laser source is a broadband long-wave infrared (LWIR) source configured to generate a LWIR beam, wherein the LWIR beam has a bandwidth equivalent to a transform-limited pulse duration of 5 picoseconds (ps) or shorter.

8. The indirect optical pumping system of claim 1, wherein the Raman resonance system comprises a pressure chamber defining an environment under pressure, and a gas within the pressure chamber including the Raman-active molecules and the gain molecules.

9. The indirect optical pumping system of claim 1, wherein the Raman-active molecules are selected from the group consisting of: nitrogen gas (N₂), carbon monoxide (CO), and a combination thereof.

10. The indirect optical pumping system of claim 1, wherein the gain molecules are selected from the group consisting of: carbon dioxide (CO₂), nitrous oxide (N₂O), and a combination thereof.

11. The indirect optical pumping system of claim 1, wherein the gas includes a buffer gas.

12. The indirect optical pumping system of claim 11, wherein the buffer gas is helium (He).

13. The indirect optical pumping system of claim 1, wherein the seed laser beam has a pulse duration of less than or equal to 5 picoseconds (ps).

14. The indirect optical pumping system of claim 1, wherein the at least one laser source comprises a first laser source and a frequency converted configured to convert a laser beam having a first frequency generated by the first laser source into another laser beam having a second frequency, wherein the first frequency is different from the second frequency.

15. An indirect optical pumping method comprising:
spatially combining a first laser beam and a seed laser beam, thereby generating a spatially combined laser beam; and
directing the spatially combined laser beam through a Raman resonance system comprising Raman-active molecules and gain molecules;
wherein the first laser beam of the spatially combined laser beam excites the Raman-active molecules, and the resulting excited Raman-active molecules excite the gain molecules, resulting in amplification of the seed laser beam such that an amplified laser beam exits the Raman resonance system.

16. The indirect optical pumping method of claim 15, further comprising:
spatially and temporally combining a pump laser beam and a Stokes laser beam, thereby generating the first laser beam.

17. The indirect optical pumping method of claim 15, further comprising: directing the amplified laser beam to a dichroic mirror, thereby separating laser energy of a predetermined wavelength or wavelengths from the amplified laser beam, resulting in an amplified seed laser beam having a higher total energy output than the seed laser beam.

18. The indirect optical pumping method of claim 17, wherein the amplified seed laser beam is a broadband long-wave infrared (LWIR) beam, wherein the LWIR beam has a bandwidth equivalent to a transform-limited pulse duration of 5 picoseconds (ps) or shorter.

19. The indirect optical pumping method of claim 15, wherein the Raman resonance system comprises a pressure chamber defining an environment under pressure, and a gas within the pressure chamber including the Raman-active molecules and the gain molecules.

20. The indirect optical pumping method of claim 19, wherein:
the Raman-active molecules are selected from the group consisting of: nitrogen gas (N₂), carbon monoxide (CO), and a combination thereof; and
the gain molecules are selected from the group consisting of: carbon dioxide (CO₂), nitrous oxide (N₂O), and a combination thereof.
